(19) United States
(12) Patent Application Publication
(10) Pub. No.: US 2015/0007118 A1
(43) Pub. Date: Jan. 1, 2015

(54) SOFTWARE DEVELOPMENT USING GESTURES

(71) Applicant: International Business Machines Corporation, Armonk, NY (US)

(72) Inventors: Anton S. McConville, Ottawa (CA); Kenneth N. Walker, Ottawa (CA)

(73) Assignee: INTERNATIONAL BUSINESS MACHINES CORPORATION, Armonk, NY (US)

(21) Appl. No.: 13/928,738

(22) Filed: Jun. 27, 2013

(51) Int. Cl. G06F 3/01

(52) U.S. Cl. CPC G06F 3/017
USPC 715/863

(57) ABSTRACT

Software development using gestures includes, receiving, in an integrated development environment (IDE), a gesture input through a gesture capture device and matching, using a processor, the gesture input to a selected gesture of a plurality of gestures. Each of the plurality of gestures is mapped to a programmatic action of the IDE. The programmatic action mapped to the selected gesture is determined. Further, the programmatic action mapped to the selected gesture is performed within the IDE.

### BACKGROUND

Within some software development environments, portions of commonly used program code may be stored for subsequent re-use. As such, when working in a project open with the software development environment, a software developer may choose to include the re-usable portion of program code into the current project. This action is often is accomplished by the user typing a predetermined set of keystrokes that, when received by the software development environment, effectively paste the re-usable program code into the current project.

### BRIEF SUMMARY

One or more embodiments disclosed within this specification relate to software development using gestures.

A method includes receiving, in an integrated development environment (IDE), a gesture input through a gesture capture device and matching, using a processor, the gesture input to a selected gesture of a plurality of gestures. Each of the plurality of gestures is mapped to a programmatic action of the IDE. The method also includes determining the programmatic action mapped to the selected gesture and performing the programmatic action mapped to the selected gesture within the IDE.

A system includes a processor programmed to initiate executable operations. The executable operations include receiving, in an IDE, a gesture input through a gesture capture device and matching the gesture input to a selected gesture of a plurality of gestures. Each of the plurality of gestures is mapped to a programmatic action of the IDE. The executable operations also include determining the programmatic action mapped to the selected gesture and performing the programmatic action mapped to the selected gesture within the IDE.

A computer program product includes a computer readable storage medium having program code stored thereon. The program code is executable by a processor to perform a method. The method includes receiving, in an IDE and using the processor, a gesture input through a gesture capture device and matching, using the processor, the gesture input to a selected gesture of a plurality of gestures. Each of the plurality of gestures is mapped to a programmatic action of the IDE. The method further includes determining, using the processor, the programmatic action mapped to the selected gesture and performing, using the processor, the programmatic action mapped to the selected gesture within the IDE.

### BRIEF DESCRIPTION OF THE SEVERAL VIEWS OF THE DRAWINGS

FIG. 1 is a block diagram illustrating an exemplary computing environment for software development using gestures.

FIG. 2 is a block diagram illustrating an example of a data processing system.

FIG. 3, in reference to FIGS. 3-1 through 3-8, illustrates exemplary gestures that are recognizable within an integrated development environment.

FIG. 4 is a flow chart illustrating an exemplary method of software development using gestures.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code embodied, e.g., stored, thereon.

Any combination of one or more computer-readable medium(s) may be utilized. The computer-readable medium may be a computer-readable signal medium or a computer-readable storage medium. A computer-readable storage medium may be, for example, but is not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. As defined herein, the term “computer-readable storage medium” means a tangible storage medium that contains or stores program code for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

This specification relates to using gestures for software development. In accordance with the inventive arrangements disclosed herein, gestures are correlated with programmatic actions available within, or as part of, an application program such as an integrated development environment (IDE). One or more or all of the gestures also can be correlated with a program code template. The program code templates can be stored within the IDE, or in a manner that makes the program code templates available to the IDE. As such, the program code templates are available for reuse.

Responsive to detecting one of the gestures, the programmatic action correlated with the detected gesture is performed or initiated. In one aspect, the programmatic action that is performed utilizes the program code template associated with the detected gesture. For example, the programmatic action can insert, or include, the program code specified by the program code template within with current project of the IDE. These and other features are described in greater detail within this specification with reference to the accompanying drawings.

Associating gestures with programmatic actions, and optionally program code templates within an IDE allows users to develop software using any of a variety of devices that support gestures. Typically, a device that supports gestures, e.g., a mobile phone or tablet computing device, has a form factor that is not well suited for manual entry of large amounts of text, e.g., source code. Creating large amounts of source code using the keyboard of such a device typically is cumbersome as such keyboards often are virtual, smaller than normal sized keyboards, or both. Incorporating gestures within an IDE allows fast and efficient creation of program code for software development when using a gesture-enabled device.

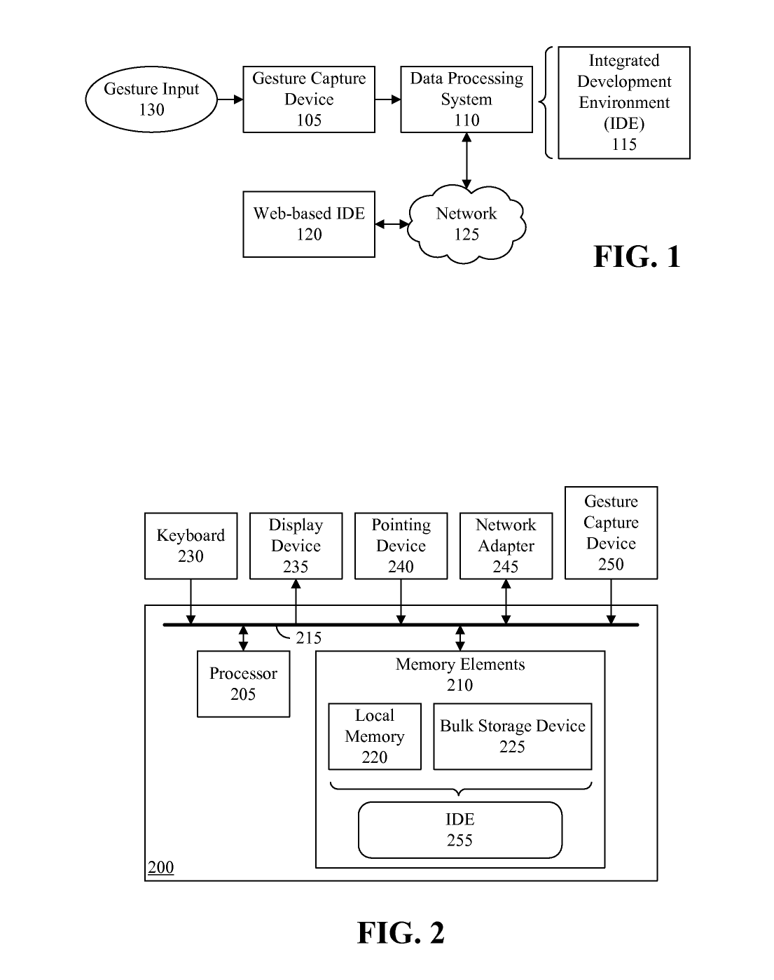

FIG. 1 is a block diagram illustrating an exemplary computing environment 100 for software development using gestures. In one aspect, computing environment 100 includes a gesture capture device 105 and a data processing system 110. In general, FIG. 1 illustrates several different use cases. A first use case is directed to the user executing an IDE locally on the user's data processing device. A second use case is directed to the user accessing a Web-based IDE, e.g., an IDE hosted or executed by a server, where the user's data processing device acts as a client to the Web-based IDE.

Gesture capture device 105 is an apparatus that detects gestures from a user. In one aspect, gesture capture device 105 is implemented as a standalone apparatus that is communicatively linked to another device such as data processing system 110. Gesture capture device 105 can be communicatively linked to data processing system 110 by a cabled connection or a wireless connection to provide gesture capture data. Examples of gesture capture device 105 include, but are not limited to, a track pad, a touchpad, a camera, a touchscreen, a touch-sensitive display, or the like. For example, gesture capture device 105 can be a peripheral device of data processing system 110. In another aspect, gesture capture device 105 is integrated into a larger device such as data processing system 110 to provide gesture capture data. For example, data processing system 110 can be implemented as a portable computing device in which gesture capture device 105 is implemented as an integrated track pad or touchpad. In another example, data processing system 110 can be implemented as a tablet computing device or mobile communication device in which gesture capture device 105 is implemented as the integrated touchscreen of the device.

It should be appreciated that other combinations and/or form factors of gesture capture device 105 and data processing system 110 can be used in practicing and/or implementing the embodiments disclosed herein. For example, a peripheral device such as a wired or wireless track pad can be communicatively linked to a portable or mobile computing device or a desktop computing device. In another example, a mobile device or tablet can function as gesture capture device 105 and be communicatively linked to data processing system 110, e.g., a computer.

In one embodiment corresponding to the first use case, data processing system 110 executes IDE 115 locally. IDE 115 is a software application that provides comprehensive facilities to computer programmers for software development. In one embodiment, IDE 115 includes a text or source code editor, built automation tools, and optionally a debugger. In another embodiment, IDE 115 further includes a compiler, an interpreter, or both. In some cases, IDE 115 includes development tools for creating and/or building a graphical user interface (GUI). While not required, IDE 115 further can include a class browser, an object browser, and/or a class hierarchy diagram for use with object-oriented software development.

In another embodiment corresponding to the second user case, data processing system 110 does not execute IDE 115 locally. Rather, data processing system 110 functions as a client and accesses a Web-based IDE 120 through a network 125. Web-based IDE 120 can be substantially similar, if not the same, in terms of functionality as IDE 115 except that the IDE software executes on a server type of data processing system. For purposes of explanation, Web-based IDE 120 refers to a data processing system executing IDE software. Accordingly, Web-based IDE 120 provides data processing system 110 with a Web-based interface through either a browser or a dedicated client application executing on data processing system 110.

Network 125 can be implemented as, or include, any of a variety of different networks such as a WAN, a LAN, a wireless network, a mobile network, a Virtual Private Network (VPN), the Internet, the Public Switched Telephone Network (PSTN), or the like. For example, data processing system 110 can communicate with Web-based IDE 120 over network 125 using Hypertext Transfer Protocol (HTTP) and/or HTTPS using Transmission Control Protocol/Internet Protocol (TCP/IP).

As shown, gesture capture device 105 receives, or detects, a gesture input 130. Gesture input 130 is a gesture that is received from a user as an input. A gesture is one or more touches, one or more movements, or one or more touches in which one or more or all of the touches move. As noted, a gesture is received or detected by gesture capture device 105 and, as such, is recognizable by data processing system 110. For example, data processing system 110 can include the program code, e.g., drivers, necessary to determine which gesture is detected by gesture capture device 105 by interpreting the gesture capture data provided by gesture capture device 105.

Examples of gestures include, but are not limited to, a single touch with or without movement of the touch, two or more touches without movement of the touches, two or more touches where one or more or all of the touches exhibit movement such as a predetermined pattern of movement, motion of one or more user body parts, for example, that may be detected by a camera, or the like. A gesture that is formed of one touch, e.g., as detected using a gesture capture device, that overlaps in time with at least one other touch is referred to as a multi-touch gesture. Thus, any gesture involving two or more touches, within this specification, is considered a multi-touch gesture.

In operation, gesture capture device 105 receives or detects gesture input 130. Gesture capture device 105 generates gesture capture data responsive to detection of gesture input 130 and provides the gesture capture data to data processing system 110. In one aspect, data processing system 110 determines a selected gesture from a plurality of gestures usable within IDE 115 that is represented by, or matches, gesture input 130. For example, data processing system 110 decodes the gesture capture data to determine which of a plurality of recognizable gestures matches the received gesture capture data.

When executing IDE 115 locally within data processing system 110, data processing system 110, responsive to determining the selected gesture represented by gesture input 130, performs one or more programmatic actions associated with the selected gesture. As noted, in some cases, gestures also are associated with program code templates. When the selected gesture is also associated with a program code template, the programmatic action is performed using the program code template.

As used within this specification, a “program code template” is a predefined set of computer instructions stored for re-use within, or by, an IDE. Typically, the program code template is specified as, or includes, source code. Still, in other aspects, the program code template can be specified as, or include, machine code, interpretable code, or the like. In any case, each program code template includes program code or a code pattern that is commonly used or referenced. Thus, the program code of a program code template can be easily re-used within a current project.

The program code template can include one or more labels that act as place holders. In one aspect, a label within a program code template is replaced with replacement program code responsive to the program code template being included within a current project of the IDE, e.g., within a session of the IDE. As used herein, a “current project” refers to an open project or active window within the IDE or, in the case of multiple open projects within the IDE, the active project or window that has focus within the IDE. In another aspect, a label of a program code template can be populated automatically according to features of a received user input, e.g., gesture input 130 that is correlated with the program code template or a further gesture input or user input.

In some cases, when a program code template includes one or more fields, the fields are replaced with replacement program code in accordance with the programmatic action that is being implemented. A programmatic action is a set of one or more operations or tasks that are pre-defined, and available within, an application. As such, a programmatic action is performed by a processor responsive to a gesture input. The programmatic action may utilize or include operating system operations.

When data processing system 110 accesses Web-based IDE 120, data processing system 120 sends a request to Web-based IDE 120 through network 125. In one aspect, the request specifies the selected gesture. In that case, Web-based IDE 120 performs the programmatic action associated with the selected gesture responsive to the request. When the selected gesture is also associated with a program code template, the programmatic action is performed by Web-based IDE 120 using the program code template.

In another aspect, the request can specify the gesture capture data received from gesture capture device 105. In that case, Web-based IDE 120 decodes the gesture capture data and determines the selected gesture represented by the gesture capture data and, as such, gesture input 130. Once the selected gesture is determined, Web-based IDE 120 performs the programmatic action associated with the selected gesture responsive to the request. When the selected gesture is also associated with a program code template, the programmatic action is performed by Web-based IDE 120 using the program code template.

FIG. 2 is a block diagram illustrating an example of a data processing system (system) 200. In one aspect, system 200 represents an exemplary implementation of data processing system 110 of FIG. 1. In another aspect, system 200 represents an exemplary implementation of Web-based IDE 120 of FIG. 1. While various architectural aspects of data processing system 110 and Web-based IDE 120 may be similar or the same, appreciably, data processing system 110 can differ from Web-based IDE 120 in terms of form factor and/or computing power or capabilities (e.g., amount of memory, speed, central processing unit, etc.).

System 200 can include at least one processor 205, e.g., a central processing unit, coupled to memory elements 210 through a system bus 215 or other suitable circuitry. As such, system 200 can store program code within memory elements 210. Processor 205 executes the program code accessed from memory elements 210 via system bus 215 or the other suitable circuitry. In one aspect, system 200 is implemented as a computer or other programmable data processing apparatus that is suitable for storing and/or executing program code. It should be appreciated, however, that system 200 can be implemented in the form of any system including a processor and memory that is capable of performing and/or initiating the functions and/or operations described within this specification.

Memory elements 210 include one or more physical memory devices such as, for example, a local memory 220 and one or more bulk storage devices 225. Local memory 220 refers to RAM or other non-persistent memory device(s) generally used during actual execution of the program code. Bulk storage device(s) 225 can be implemented as a hard disk drive (HDD), solid state drive (SSD), or other persistent data storage device. System 200 also can include one or more cache memories (not shown) that provide temporary storage of at least some program code in order to reduce the number of times program code must be retrieved from bulk storage device 225 during execution.

Input/output (I/O) devices such as a keyboard 230, a display 235, and a pointing device 240 optionally can be coupled to system 200. The I/O devices can be coupled to system 200 either directly or through intervening I/O controllers. One or more network adapters 245 also can be coupled to system 200 to enable system 200 to become coupled to other systems, computer systems, remote printers, and/or remote storage devices through intervening private or public networks. Modems, cable modems, wireless transceivers, and Ethernet cards are examples of different types of network adapters 245 that can be used with system 200.

System 200 further can be coupled to, or include, a gesture capture device 250. Such is the case, for example, when system 200 executes an IDE locally as a user system as opposed to implementing a Web-based IDE. Gesture capture device 250 can be implemented as described with reference to gesture capture device 105 of FIG. 1. It should be appreciated that one or more of the I/O devices can be combined or implemented as a single device depending upon the form factor of system 200. For example, when implemented as a mobile device or other portable computing device, keyboard 230, display device 235, pointing device 240, and gesture capture device 250 can be implemented by a single device, e.g., a touch screen. In another example, a track pad or touchpad can implement pointing device 240 and gesture capture device 250.

As pictured in FIG. 2, memory elements 210 can store an IDE 255. IDE 255, being implemented in the form of executable program code, is executed by system 200 and, as such, is considered an integrated part of system 200. Moreover, IDE 255, including any parameters and/or attributes utilized by IDE 255, e.g., gestures, gesture capture data, program code templates, programmatic operations, etc., are functional data structures that impart functionality when employed as part of system 200.

In the case where system 200 represents Web-based IDE 120 of FIG. 1, it should be appreciated that system 200 also can represent an exemplary architecture for any of a variety of client devices. The client device does not execute IDE 255. Instead, the client device executes suitable program code such as a browser or an application that is configured to interact with system 200 over a network.

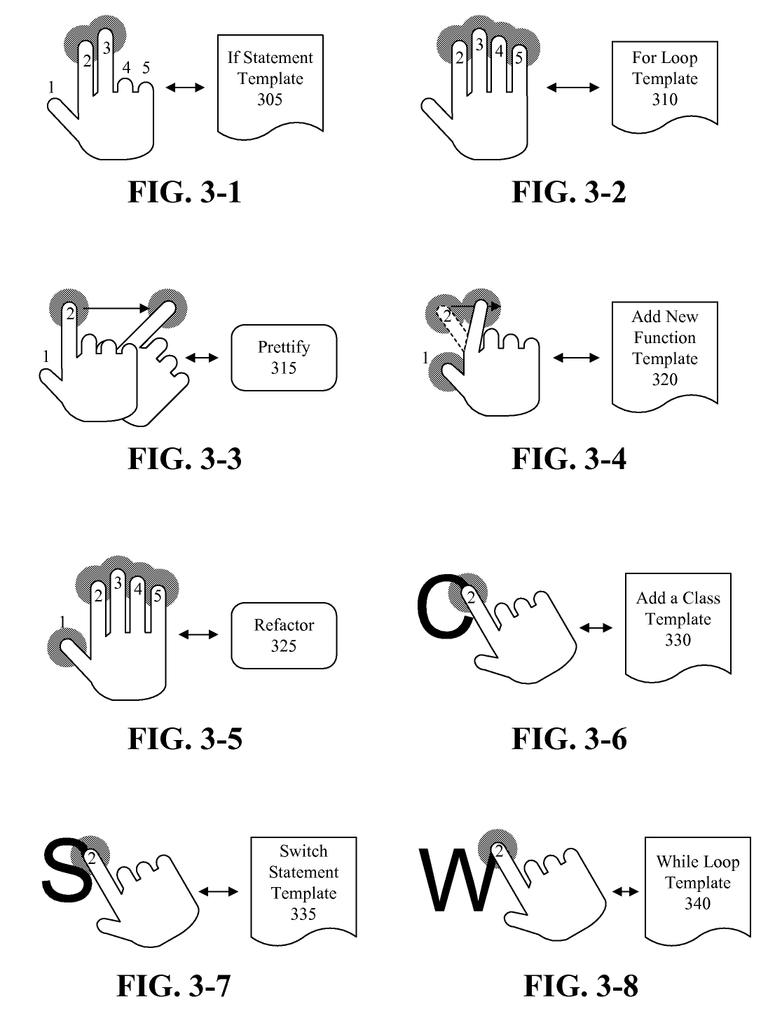

FIG. 3, in reference to FIGS. 3-1 through 3-8, illustrates exemplary gestures that are recognizable within an IDE. FIG. 3 uses a common notation in which a touch by a finger is represented by a shaded region beneath that finger. Movement of a finger or fingers is represented by a directional arrow. A movement pattern by one or more fingers is represented by a solid line indicating the pattern of movement by the finger(s). For purposes of discussion, fingers are numbered 1-5 as illustrated in FIG. 3-1.

As discussed, each gesture can be correlated, or associated, with a programmatic action and, optionally, a program code template. FIG. 3-1 illustrates an example in which a gesture is associated with a programmatic action and a program code template. In the example of FIG. 3-1, a gesture in which the user touches or makes contact with a gesture capture device using fingers 2 and 3 is shown. Responsive to detecting the gesture during operation of an IDE, e.g., during a session, the programmatic action associated with the gesture inserts the program code specified by the program code template illustrated as If Statement Template 305 into the current project. The program code can be inserted at an insertion point within the current project. The insertion point, for example, can be the location of a cursor or a pointer for the current project. Exemplary program code that can be included in If Statement Template 305 is shown below.

```
if ( STATEMENT ) {
      BODY
      }
```

In this example, If Statement Template 305 includes two labels. Each label represents a placeholder that is intended to be replaced with replacement program code supplied or indicated by the software developer or user. In this example, the labels are “STATEMENT” and “BODY.” The STATEMENT label is a placeholder for replacement program code specifying the condition to be met, while the BODY label is a placeholder for replacement program code having one or more instructions that are executed when STATEMENT evaluates to true. In one aspect, the program code of If Statement Template 305 can be inserted into the current project with the labels still present within the program code as shown above. The software developer can add program code as required at a later time to replace the labels. It should be appreciated, however, that replacement program code for a label can be determined according to any of a variety of different techniques. For example, replacement program code can be determined according to the received gesture, a subsequent user input, and/or from a clipboard of the system.

In illustration, a label within the program code template can be automatically replaced with content of the clipboard. The clipboard of a system refers to a software function that allows data or content to be stored short-term thereby allowing the content to be copied and pasted between documents and/or applications. Thus, when the program code of If Statement Template 305 is inserted into the current project, the contents of the clipboard are inserted into If Statement Template 305 in place of STATEMENT and/or BODY automatically. The software developer, for example, can copy the replacement program code used to replace STATEMENT or BODY in the clipboard as the case may be prior to forming the gesture of FIG. 3-1.

In another illustration, a first gesture can be associated with a first programmatic action and If Statement Template 305, while a second and different gesture is associated with a second programmatic action and If Statement Template 305. The first gesture executes the first programmatic action that inserts the program code of If Statement Template 305 into the current project with the labels as shown above. The second gesture executes the second programmatic action that replaces one or more of the labels with the content of the clipboard.

In still another illustration, the system, responsive to detecting a gesture such as the second gesture, can query the user as to which label the content of the clipboard is to replace within the program code template. The user can respond to the query with a further user input which may be a gesture input or other standard form of user input to select the particular label to be replaced. It should be appreciated that the first gesture and the second gesture in this example need only be differentiated by one additional feature. For example, the second gesture can be similar to that of the first gesture, but include a further feature or differentiator indicating that the content of the clipboard of the system is to be inserted into the program code of the program code template in place of the label.

Consider an example in which the gesture illustrated in FIG. 3-1 is detected. Responsive to detecting the gesture, the system inserts the program code of If Statement Template 305 into the current project of the IDE. Responsive to a subsequent gesture input, the system inserts content of the clipboard of the system into the program code of the program code template within the current project in place of a label. When the program code template includes more than one label, the system can query the user as to which label the content of the clipboard is to replace. The content of the clipboard is then inserted into the program code of the program code template within the active project in place of the selected label.

Consider another example in which the system queries the user for an expression or program code that is used to replace the label(s). For example, the system can present a dialog that steps through each label of the program code template associated with the detected gesture. For each label, the user can respond with gesture input or other user input that specifies program code (e.g., by typing), specifies that the label be replaced with content from the clipboard of the system, selects from predetermined options, e.g., variables such as “i”, “x”, etc., that are to be used to replace the label.

In yet another example, the system can determine program code to be used in place of labels by an analysis of the program code and other contextual information around the insertion point of the program code template. For example, the variable to be used in a “for” loop can be determined from one or more lines of code above, below, or above and/or below the insertion point of the program code template.

FIG. 3-2 illustrates an example in which the detected gesture is fingers 2, 3, 4, and 5 making contact with the gesture detection device. The programmatic action associated with the gesture in FIG. 3-2 is one that inserts the program code of For Loop Template 310 into the current project at a specified location, e.g., the insertion point. Exemplary program code specified by For Loop Template 310 is illustrated below.

```
int main( )
      {
            int VARIABLE;
            for (VARIABLE = 0; VARIABLE < UPPER_BOUND;
            VARIABLE ++)
            {
            BODY
            }
      return 0;
      }
```

In the example illustrated above, For Loop Template 310 includes three labels shown as VARIABLE, UPPER_BOUND, and BODY. The handling of labels and any replace thereof with replacement program code can be performed using any of the mechanisms previously described.

FIG. 3-3 illustrates an example in which the detected gesture is finger 2 making contact with the gesture capture device and swiping horizontally from left to right. In this example, the gesture is not associated with a program code template. The gesture of FIG. 3-3 is, however, associated with a programmatic action called Prettify 315. Execution of Prettify 315 results in the system formatting the program code, e.g., source code, of the current project, e.g., the active window, to place the program code in an ordered and readable format. For example, Prettify 315 can add tabs, spacing, line breaks, align program code, and the like according to a predetermined convention used by the IDE.

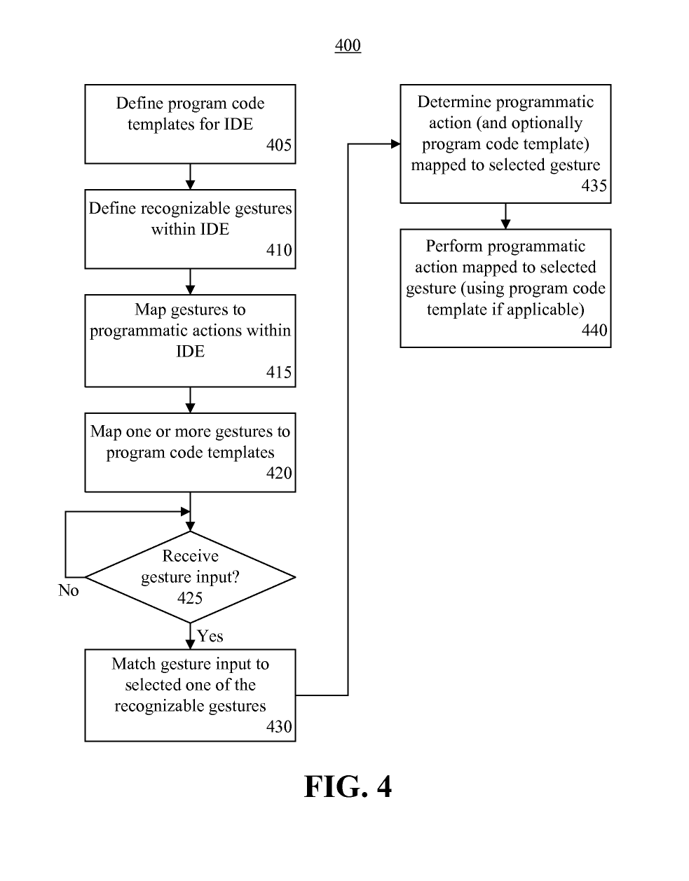

FIG. 3-4 illustrates an example in which the detected gesture is finger 1 making contact with the gesture capture device and remaining still while finger 2 makes contact with the gesture capture device concurrently with finger 1 and swipes from left to right. The programmatic action associated with the gesture in FIG. 3-4 is one that inserts the program code of Add New Function Template 320 into the current project at the insertion point. Handling of labels that may be included within Add New Function Template 320, if any, can be performed as described herein.

FIG. 3-5 illustrates an example in which the detected gesture is each of fingers 1, 2, 3, 4, and 5 making contact with the gesture capture device and not moving. In this example, the gesture is not associated with a program code template. The gesture of FIG. 3-5 is, however, associated with a programmatic action called Refactor 325. Execution of Refactor 325, for example, renames one or more identifiers within the program code of the current project, e.g., an active window. In some cases, the renaming is context sensitive.

FIG. 3-6 illustrates an example in which the detected gesture is finger 1 making contact with the gesture capture device and moving to form a “C” pattern. The programmatic action associated with the gesture in FIG. 3-6 is one that inserts the program code of Add a Class Template 330 into the current project at the insertion point. Handling of labels that may be included within Add a Class Template 330, if any, can be performed as described herein.

FIG. 3-7 illustrates an example in which the detected gesture is finger 1 making contact with the gesture capture device and moving to form an “S” pattern. The programmatic action associated with the gesture in FIG. 3-7 is one that inserts the program code of Switch Statement Template 335 into the current project at the insertion point. Handling of labels that may be included within Switch Statement Template 335, if any, can be performed as described herein.

FIG. 3-8 illustrates an example in which the detected gesture is finger 1 making contact with the gesture capture device and moving to form a “W” pattern. The programmatic action associated with the gesture in FIG. 3-8 is one that inserts the program code of While Loop Template 340 into the current project at the insertion point. Handling of labels that may be included within While Loop Template 340, if any, can be performed as described herein.

The various gestures illustrated with reference to FIG. 3 are provided for purposes of illustration only. As such, the gestures, the programmatic actions, and the program code templates described are not intended to limit the various embodiments disclosed herein. Any of a variety of gestures can be used and correlated with programmatic actions and, optionally, program code templates. The program code templates further can include zero or more labels as appropriate. The various gestures illustrated are application-specific in that the gestures invoke the programmatic actions described within a system that is executing an IDE for software development.

FIG. 4 is a flow chart illustrating an exemplary method 400 of software development using gestures. Method 400 can be performed by any of the various systems described with reference to FIGS. 1 and 2 according to any of the various use cases described. Accordingly, method 400 can begin in block 405 where one or more program code templates are defined for the IDE. As noted, program code templates may, but need not, include labels acting as place holders for replacement program code to be inserted or used within the program code template once inserted into a current project within the IDE. In block 410, a set of one or more recognizable gestures are defined for use within the IDE.

In block 415, the gestures are mapped to programmatic actions within the IDE. For example, each gesture is mapped to one programmatic action. The programmatic action can be any function that can be invoked within the IDE including insertion of program code from a program code template at a designated location referred to as an insertion point within the current project. As noted, the insertion point can be indicated by a cursor or pointer. In some cases, the programmatic action correlated with the gesture may cause the program code of a program code template to be inserted at the beginning of a window (prepended) or at the end of a window (appended). Such action can depend upon the gesture and correlated programmatic action as previously described. In any case, in block 420, one or more of the gestures further can be mapped to the program code templates. In one aspect, a gesture is mapped to a single program code template.

In block 425, while the system is executing the IDE, e.g., in an ongoing or open session of the IDE, the system determines whether a gesture input has been received. If so, method 400 continues to block 430. If not, method 400 loops back and continues to check for a received gesture input. In block 430, the system matches the gesture input to a selected one of the recognizable gestures. For example, the system decodes the received gesture capture data and selects the particular recognizable gesture that best matches, or most closely matches, the gesture capture data. In block 435, the system determines the programmatic action that is mapped to the selected gesture. If a program code template is also mapped to the gesture, the program code template also is determined.

In block 440, the system performs the programmatic action that is mapped to, or correlated with, the selected gesture. In the event the selected gesture is also associated with a program code template, the programmatic action is performed using the program code template. In one aspect, the programmatic action includes the program code specified by the program code template at an insertion point within the current project within the IDE, e.g., within an ongoing session of the IDE. When including the program code of the program code template within a current project, labels can be replaced with replacement program code using any of the various mechanisms or techniques described within this specification.

The embodiments disclosed within this specification allow users to utilize gestures for software development. By associating gestures with programmatic actions, and optionally program code templates within an IDE, a user may develop software using any of a variety of devices that support gestures. Devices that support gestures tend to have text entry mechanisms that are cumbersome to use thereby inhibiting effective entry of program code into an IDE. Incorporating gestures within an IDE facilitates IDE usage by gesture-enabled devices that would otherwise be difficult to use for software development purposes.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Reference throughout this specification to “one embodiment,” “an embodiment,” or similar language means that a particular feature, structure, or characteristic described in connection with the embodiment is included in at least one embodiment disclosed within this specification. Thus, appearances of the phrases “in one embodiment,” “in an embodiment,” and similar language throughout this specification may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The corresponding structures, materials, acts, and equivalents of all means or step plus function elements in the claims below are intended to include any structure, material, or act for performing the function in combination with other claimed elements as specifically claimed. The description of the embodiments disclosed within this specification has been presented for purposes of illustration and description, but is not intended to be exhaustive or limited to the form disclosed. Many modifications and variations will be apparent to those of ordinary skill in the art without departing from the scope and spirit of the embodiments of the invention. The embodiments were chosen and described in order to best explain the principles of the invention and the practical application, and to enable others of ordinary skill in the art to understand the inventive arrangements for various embodiments with various modifications as are suited to the particular use contemplated.

What is claimed is:

1. A system comprising:
a processor programmed to initiate executable operations comprising:
receiving, in an integrated development environment, a gesture input through a gesture capture device;
matching the gesture input to a selected gesture of a plurality of gestures, wherein each of the plurality of gestures is mapped to a programmatic action of the integrated development environment;
determining the programmatic action mapped to the selected gesture; and
performing the programmatic action mapped to the selected gesture within the integrated development environment.

2. The system of claim 1, wherein the selected gesture and the gesture input are a multi-touch gesture.

3. The system of claim 1, wherein the selected gesture is further mapped to a program code template.

4. The system of claim 3, wherein performing the programmatic action mapped to the selected gesture comprises:
inserting program code of the program code template into a current project within the integrated development environment.

5. The system of claim 4, wherein the program code template includes a label, wherein the processor is further programmed to initiate executable operations comprising:
determining replacement program code for the label; and
replacing the label with the replacement program code within the current project;
wherein the replacement program code is determined according to the gesture input.

6. The method of claim 4, wherein the program code template includes a label, wherein the processor is further programmed to initiate executable operations comprising:
determining replacement program code for the label; and
replacing the label with the replacement program code within the current project;
wherein the replacement program code is determined according to a subsequent user input.

7. The method of claim 4, wherein the program code template includes a label, wherein the processor is further programmed to initiate executable operations comprising:
replacing the label, within the current project, with content from a clipboard of a data processing system.

8. A computer program product comprising a computer readable storage medium having program code stored thereon, the program code executable by a processor to perform a method comprising:
receiving, in an integrated development environment and using the processor, a gesture input through a gesture capture device;
matching, using the processor, the gesture input to a selected gesture of a plurality of gestures, wherein each of the plurality of gestures is mapped to a programmatic action of the integrated development environment;
determining, using the processor, the programmatic action mapped to the selected gesture; and
performing, using the processor, the programmatic action mapped to the selected gesture within the integrated development environment.

9. The computer program product of claim 8, wherein the selected gesture and the gesture input are a multi-touch gesture.

10. The computer program product of claim 8, wherein the selected gesture is further mapped to a program code template.

11. The computer program product of claim 10, wherein performing the programmatic action mapped to the selected gesture comprises:
inserting program code of the program code template into a current project within the integrated development environment.

12. The computer program product of claim 11, wherein the program code template includes a label, the method further comprising:
determining replacement program code for the label; and
replacing the label with the replacement program code within the current project;
wherein the replacement program code is determined according to the gesture input.

13. The computer program product of claim 11, wherein the program code template includes a label, the method further comprising:
determining replacement program code for the label; and
replacing the label with the replacement program code within the current project;
wherein the replacement program code is determined according to a subsequent user input.

14. The computer program product of claim 11, wherein the program code template includes a label, the method further comprising:
replacing the label, within the current project, with content from a clipboard of a data processing system.
